(19) United States
(12) Patent Application Publication
(10) Pub. No.: US 2025/0156655 A1
(43) Pub. Date: May 15, 2025

(54) METHOD FOR GENERATING FILE, ELECTRONIC DEVICE AND STORAGE MEDIUM

(71) Applicant: Baidu International Technology (Shenzhen) Co., Ltd., Shenzhen (CN)

(72) Inventors: Chao Huang, Shenzhen (CN); Gang Qiao, Shenzhen (CN); Zhenpeng Zhan, Shenzhen (CN)

(21) Appl. No.: 19/020,179

(22) Filed: Jan. 14, 2025

(30) Foreign Application Priority Data
Jul. 12, 2024 (CN) 202410936185.0

(51) Int. Cl. G06F 40/40; G06F 16/9032

(52) U.S. Cl. CPC G06F 40/40; G06F 16/90332

(57) ABSTRACT

A method for generating a file, an electronic device, and a storage medium are disclosed. The method includes inputting M1 first-type files into a first model, and outputting second-type files corresponding to the respective first-type files from the first model; determining a plurality of file pairs according to an output result, wherein each file pair includes a first-type file and a second-type file corresponding to the first-type file; adjusting a second model by using the plurality of file pairs; and inputting M2 first-type files into an adjusted second model, and outputting the second-type files corresponding to the respective first-type files from the adjusted second model, wherein M1 and M2 are positive integers.

### CROSS-REFERENCE TO RELATED APPLICATIONS

The present application claims priority to Chinese Patent Application No. CN202410936185.0, filed with the China National Intellectual Property Administration on Jul. 12, 2024, the disclosure of which is hereby incorporated herein by reference in its entirety.

### TECHNICAL FIELD

The present disclosure relates to the field of computer technology, and in particular, to the fields of artificial intelligence, neural network model and large language model.

### BACKGROUND

Before put into application, a neural network model is often trained with large-scale high-quality training samples. The quality and scale of the training samples are crucial for the performance and application effect of the neural network model.

### SUMMARY

The present disclosure provides a method and apparatus for generating a file, a device, and a storage medium.

According to an aspect of the present disclosure, provided is a method for generating a file, including:
inputting M1 first-type files into a first model, respectively, and outputting second-type files corresponding to the respective first-type files from the first model;
determining a plurality of file pairs according to an output result, where each file pair includes a first-type file and a second-type file corresponding to the first-type file;
adjusting a second model by using the plurality of file pairs; and
inputting M2 first-type files into an adjusted second model, respectively, and outputting the second-type files corresponding to the respective first-type files from the adjusted second model, where M1 and M2 are positive integers.

An apparatus for generating a file includes:
a first input module, configured to input M1 first-type files into a first model, respectively, and output second-type files corresponding to the respective first-type files from the first model;
a determination module, configured to determine a plurality of file pairs according to an output result, where each file pair includes a first-type file and a second-type file corresponding to the first-type file;
an adjustment module, configured to adjust the second model by using the plurality of file pairs; and
a second input module, configured to input M2 first-type files into an adjusted second model, respectively, and output the second-type files corresponding to the respective first-type files from the adjusted second model, where M1 and M2 are positive integers.

According to another aspect of the present disclosure, provided is an electronic device including:
at least one processor; and
a memory connected in communication with the at least one processor,
where the memory stores an instruction executable by the at least one processor, and the instruction, when executed by the at least one processor, enables the at least one processor to execute any method according to the examples of the present disclosure.

According to another aspect of the present disclosure, provided is a non-transitory computer readable storage medium storing a computer instruction, where the computer instruction causes a computer to perform any methods according to the examples of the present disclosure.

According to another aspect of the present disclosure, provided is a computer program product including a computer program, where the computer program, when executed by a processor, implements any methods according to the examples of the present disclosure.

The present disclosure provides a method and apparatus for generating a file, and a file generated by the method can be used as a training sample of a neural network model. Specifically, a plurality of file pairs are generated by using a first model, and each file pair includes a first-type file and a second-type file corresponding to the first-type file; and a second model is adjusted by using the file pairs; then corresponding a plurality of second-type files are generated based on the plurality of first-type files by adopting the adjusted second model; the second-type file can be used as a training sample of other neural network models. By mean of the scheme, the second model can be trained by using the training sample generated by the first model, and then the trained second model generates training samples of other neural network models, so as to provide a new training sample generation scheme which can be free of manual annotation to save the cost; and by utilizing the generation capability of the first model, the generated files can cover various domains and situations, so that the quantity and the diversity of the generated files are improved.

It should be understood that the content described in this part is not intended to identify critical or essential features of examples of the present disclosure, nor is it used to limit the scope of the present disclosure. Other features of the present disclosure will be easily understood through the following description.

### BRIEF DESCRIPTION OF THE DRAWINGS

The accompanying drawings are used to better understand the present solution, and do not constitute a limitation to the present disclosure, in which:

FIG. 1 is a schematic diagram illustrating an application scenario according to an example of the present disclosure;

FIG. 2 is a flowchart illustrating an implementation of a method for generating a file according to an example of the present disclosure;

FIG. 3 is a schematic diagram illustrating a first stage of a method for generating a file according to the example of the present disclosure;

FIG. 4 is a schematic diagram illustrating a second stage of a method for generating a file according to the example of the present disclosure;

FIG. 5 is a schematic diagram illustrating a third stage of a method for generating a file according to the example of the present disclosure;

FIG. 6 is a schematic block diagram illustrating an apparatus 600 for generating a file according to an example of the present disclosure; and

FIG. 7 is a schematic block diagram illustrating an exemplary electronic device 700 that may be used to implement examples of the present disclosure.

### DETAILED DESCRIPTION

Hereinafter, descriptions to exemplary examples of the present disclosure are made with reference to the accompanying drawings, include various details of the examples of the present disclosure to facilitate understanding, and should be considered as merely exemplary. Therefore, those having ordinary skill in the art should realize, various changes and modifications may be made to the examples described herein, without departing from the scope and spirit of the present disclosure. Likewise, for the sake of clarity and conciseness, descriptions of well-known functions and structures are omitted in the following descriptions.

The term “and/or” in the examples indicates that there may be three kinds of relations, for example, A and/or B may indicate that there is only A exists, or there are both A and B exist, or there is only B exists. The term “at least one” herein indicates any one of many items, or any combination of at least two of the many items, for example, “at least one of A, B, or C” may indicate any one or more elements selected from a set of A, B, and C. The term “first” and “second” herein indicate a plurality of similar technical terms and use to distinguish them from each other, but do not limit an order of them or limit that there are only two items, for example, a first feature and a second feature indicate two types of features/two features, a quantity of the first feature may be one or more, and a quantity of the second feature may also be one or more.

Before put into application, a neural network model is often trained with large-scale high-quality training samples. The quality and scale of the training samples are crucial for the performance and application effect of the neural network model. Taking a Large Language Model (LLM) for example, when applied to a vertical domain, the Large Language Model often needs to be supervised and fine-tuned by large-scale high-quality dialogue corpus (or called dialogue-type corpus or dialogue-level corpus), and the quality and scale of the corpus determines the upper limit of the Large Language Model applied to the vertical domain. The quality of the dialogue corpus refers to the accuracy, consistency and expression reasonability of dialogue contents in the dialogue corpus, which are important for the performance and application effect of the model.

Accuracy means that a dialog content should be based on a reliable source of information, verified and reviewed to ensure the authenticity and trustworthiness of information. The accuracy also includes understanding and proper application of a specific domain and terminology to avoid misleading or erroneous information conveying.

Consistency means that a model's response to the same question or context are to be consistent across different conversations. This requires the author or annotator of the dialogue corpus to apply a consistent understanding and standard, ensuring the coherence and reliability of the model's output.

The larger the corpus scale, the richer the knowledge reserve and responsiveness of the model in a specific domain. The use of large-scale corpus can help the model to better understand and answer questions in a specific domain, and provide more accurate and comprehensive information.

It can be seen that the quality and scale of the dialogue corpus have a significant impact on the application of the large language model in the vertical domain. Only by fine-tuning the model with a large quantity of dialogue corpora, the model can better adapt to the needs of a specific domain and provide high-quality and accurate answers and solutions. Therefore, constructing and maintaining a high-quality and large-scale dialogue corpus library is crucial to improve the application potential of the large language model in the vertical domain.

In the related art, there are various implementations to obtain files that can serve as model training samples. Here are some commonly used implementations:

(1) Manual Annotation: This is one of the most common methods currently, where a dedicated annotator annotates files to ensure the accuracy and consistency of training samples. The method is costly and requires a significant quantity of human resources and time.

(2) Involvement of experts in vertical domain: Experts from vertical domain are invited to participate in the annotation of files. They can provide domain-specific knowledge, ensuring the accuracy and reasonability of the training samples within the vertical domain. The method can improve the quality of the corpus, but it requires close collaboration with the experts and careful scheduling of their time and resources. This may limit the speed and scale of corpus generation and increase the costs on communication and coordination with the experts.

(3) In-domain Data Collection: Internal data resources from the vertical domain, such as internal dialogue records and chat records, are leveraged. The data can be combed and processed to transform into high-quality training samples. The method allows for the full use of in-domain knowledge and resources, but it may face a challenge of a limited data scale. Additionally, obtaining files from specific domains, especially in emerging domains or domains involving sensitive information, can be difficult. This may result in a limited scale and diversity of the training sample library.

(4) Data Alignment and Transfer Learning: By existing general domain training sample libraries and techniques such as data alignment and transfer learning, data can be converted into training samples suitable for the vertical domain. The method can reduce the dependency on emerging domain corpus, but it still requires some level of human involvement and domain knowledge.

It could be seen that the existing method for generating the training sample has the problems such as manual annotation, high cost, and limited scale and diversity. The above description is given by taking the generation of a training sample for training a large language model for example. In the related art, for a neural network model with other functions, such as an image recognition model and a classification model, when training samples for training the neural network model are generated, the problems of manual annotation, high cost and limited scale and diversity still exist.

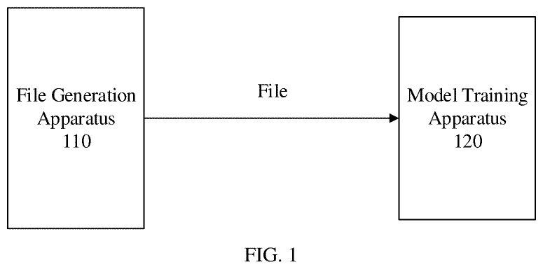

In order to solve the above problems, an example of the present disclosure provides a method for generating a file, and the file generated by using the method may be used as a training sample of a neural network model. FIG. 1 is a schematic diagram illustrating an application scenario according to an example of the present disclosure. As shown in FIG. 1, the schematic diagram of the application scenario according to the example of the present disclosure may include, but is not limited to, a file generation apparatus 110 and a model training apparatus 120. The file generation apparatus 110 and the model training apparatus 120 may communicate with each other via any type of wired or wireless network. Specifically, the file generation apparatus 110 can generate a file that can be used as a training sample of the neural network model, and send the file to the model training apparatus 120; the model training apparatus 120 may be configured to receive the file and train or fine tune the neural network model using the file. The file generation apparatus 110 and the model training apparatus 120 according to the example of the present disclosure may include an electronic device or a server. In addition, the quantity of the file generation apparatuses 110 or the model training apparatuses 120 is not limited in the example of the present disclosure. For example, the schematic diagram of the application scenario of the example of the present disclosure may include one or more file generation apparatuses 110 and/or model training apparatuses 120.

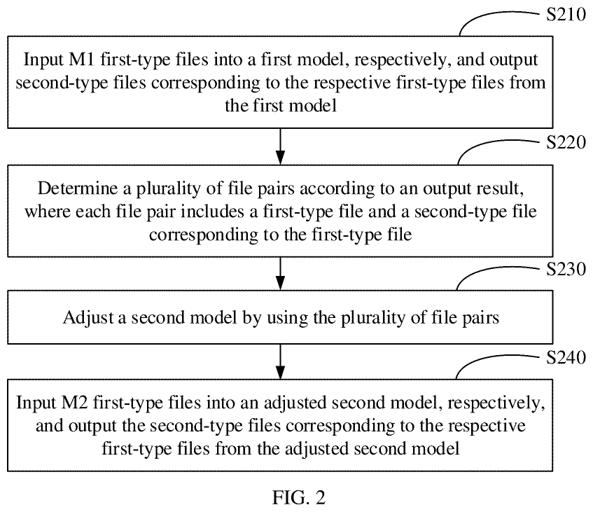

FIG. 2 is a flowchart illustrating an implementation of a method for generating a file according to an example of the present disclosure, including:
S210, inputting M1 first-type files into a first model, respectively, and outputting second-type files corresponding to the respective first-type files from the first model;
S220, determining a plurality of file pairs according to an output result, where each file pair includes a first-type file and a second-type file corresponding to the first-type file;
S230, adjusting a second model by using the plurality of file pairs; and
S240, inputting M2 first-type files into an adjusted second model, respectively, and outputting the second-type files corresponding to the respective first-type files from the adjusted second model,
where M1 and M2 are positive integers.

In some implementations, the first model may include an existing public-oriented large language model, which is large in scale and may serve a variety of different users; the second model may include an efficient low-cost language model, which is an own model with a small scale and low cost and which can be used for a specific vertical domain.

According to the example of the present disclosure, a large-scale large language model and a high-efficiency low-cost language model are combined to generate a file which can be used as a training sample or a corpus of other models, so that the scheme can be free of manual annotation to save the cost; in addition, by utilizing the generation capability of the large language model, the generated files can cover various domains and situations, so that the quantity and the diversity of the generated files are improved.

When generating the file to be used as the training sample or corpus using the existing large language model, it is a relatively conceivable way to generate all training samples or corpora using the large language model. However, since the use cost of large language models is high and a large quantity of these models need to be used to generate a huge quantity of training samples or corpus, the overall cost of the method is high; in addition, in a generation process, data needs to be input into the large language model. Since the large language model provides services for the public, the safety of the data cannot be guaranteed.

The method for generating a file according to the example of the present disclosure is implemented by adopting the existing large language model and the high-efficiency and low-cost own language model, where a portion of first-type files (such as the M1 first-type files in the above scheme) are input into the large language model, respectively, the large language model outputs corresponding M1 second-type files, respectively, and one first-type file and one corresponding second-type file can constitute a file pair, and thus a total of M1 file pairs (for convenience of description, a data cleaning process is not considered temporarily here; and if the cleaning process is considered, the quantity of the file pairs will be less than M1) are constituted. The first-type file can be a file from a specific vertical domain, and thus the generated M1 file pairs also correspond to the specific vertical domain.

The M1 file pairs may be used to adjust the second model. For example, the second model is a pre-trained language model and is an own model. The example of the present disclosure uses the file pair generated by the first model to adjust the second model (for example, performing a supervised fine-tuning). The adjustment process can improve the capability of the second model in the specific vertical domain. Then, a large quantity of first-type files (such as the M2 first-type files in the above scheme) are input into the adjusted second models, respectively, and the large language model outputs corresponding M2 second-type files, respectively, where the M2 second-type files can be used as training samples or corpus of other models for training the capabilities of other models in the specific vertical domain.

In some implementations, M2 can be greater than M1, e.g., M2 is much greater than M1 (M2>>M1); in this way, a small quantity of first-type files may be input into the first model (e.g., the existing large language model); the file pairs are constructed by using the output result of the existing large language model, and an own language model is adjusted by using the file pairs; and then a large quantity of first-type files are input into the adjusted own language model, so that a large quantity of second-type files are output from the adjusted own language model and serve as training samples or corpora of other models. In such a manner, the use of the existing large language model can be reduced as much as possible, so as to reduce the cost.

In some implementations, the M2 first-type files input into the adjusted own language model (i.e., the second model) include a file that needs to be secured, and the M1 first-type files input to the existing large language model (i.e., the first model) may be files that have a lower security requirement. Therefore, the files to be secured do not need to be revealed to the outside and can be converted locally by using the own language model, so that the data safety can be effectively protected.

It can be seen that the method for generating the file according to the example of the present disclosure can achieve both cost saving and data security by combining the existing large language model with the own language model.

The first-type file and the second-type file according to the example of the present disclosure may be in various forms. For example, the first-type file can be a chapter corpus, and the second-type file can be a dialogue corpus; or the first-type file can be a dialogue corpus and the second-type file can be a chapter corpus; or the first-type file can be a text (such as a chapter or a dialogue), and the second-type file can be an image, a video or a cartoon; or the first-type file can be an image, a video or a cartoon, and the second-type file can be a text (such as a chapter or a dialogue); or the first-type file can be a text (such as a chapter), and the second-type file can be an article outline corresponding to the text; or the first-type file can be an article outline, and the second-type file can be a text (such as a chapter) corresponding to the article outline; and so on. The specific types of the first-type file and the second-type file are not limited in the example of the present disclosure, and the first model and the second model involved in the example of the present disclosure may also be other types of models, such as a Multimodal Large Language Model (MLLM) which can combine information from a plurality of modalities (such as a text, images and videos) to perform richer natural language generation and understanding.

Hereinafter, description will be given by taking an example where the first-type file is a chapter corpus and the second-type file is a dialogue corpus. The chapter corpus can include books, articles, blogs, research reports, for example. The chapter is a language expression form with complete organization, forming a complete article or work by organically organizing various sentences and paragraphs through uniform theme and logical relations. The dialogue corpus, which includes conversation content between two or more people, may include a plurality of dialogue questions and answers to the respective dialogue questions.

The method for generating the file according to the example of the present disclosure includes the following stages.

First Stage: a chapter corpus is collected and converted into a dialogue corpus.

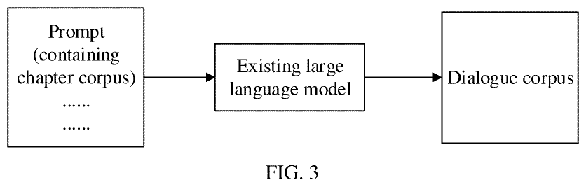

FIG. 3 is a schematic diagram illustrating a first stage of a method for generating a file according to the example of the present disclosure. In the first stage, a small quantity of chapter corpora (denoted as P in the example) from a specific vertical domain are collected. The chapter corpora may include books, blogs, and research reports, for example. The existing large language model is used in combination with a specific prompt (prompt) to convert the chapter corpus Pinto a corresponding dialogue corpus (denoted as D in the example). The prompt may contain the content of the chapter corpus P. Through this step, Ml file pairs (or input/output pairs) are obtained, where each file pair includes a chapter corpus and its corresponding dialogue corpus, denoted as (chapter corpus P, dialogue corpus D). The chapter corpus and the dialogue corpus in this stage can correspond to a specific vertical domain. For example, the chapter corpus from a specific vertical domain is collected, and the dialogue corpus generated by the existing large language model based on the chapter corpus will also correspond to the specific vertical domain.

Second Stage: the own language model is fine-tuned.

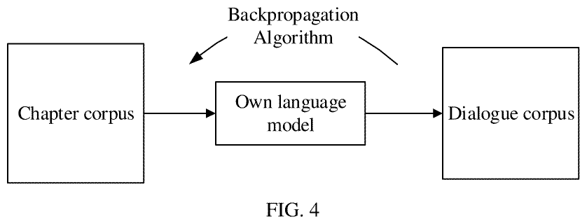

FIG. 4 is a schematic diagram illustrating a second stage of a method for generating a file according to the example of the present disclosure. In this stage, supervised fine-tuning of the own language model is performed using the Ml file pairs (or input/output pairs) collected in the first stage. For example, a backpropagation algorithm is used to fine-tune the own language model. Specifically, the chapter corpus in the file pair is used as a training sample; the corresponding dialogue corpus is used as a label for the training sample; the training sample is input into the own language model, which then outputs the corresponding dialogue corpus; an output dialogue corpus is compared with the label of the training sample; and parameters of the own language model are adjusted based on a comparison result, thereby achieving supervised fine-tuning of the own language model. The fine-tuning process can enhance the dialogue generation capability of the own language model in a specific vertical domain corresponding to the file pair. The language model at this stage is a high-efficiency and low-cost small model.

Third Stage: a large-scale, high-quality dialogue corpus is generated.

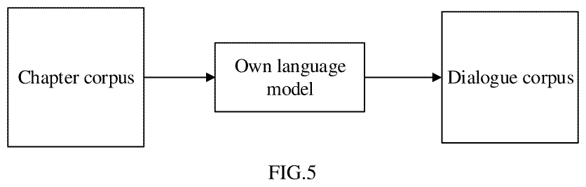

FIG. 5 is a schematic diagram illustrating a third stage of a method for generating a file according to the example of the present disclosure. In this stage, a larger-scale chapter corpus, such as M2 chapter corpus (where M2 is much greater than M1), is input into the fine-tuned high-efficiency and low-cost small model. As a result, the high-efficiency and low-cost small model can output a large-scale, high-quality dialogue corpus, meeting the requirement of the specific vertical domain. The chapter corpus used in this stage can be collected from sources such as books, research reports, and blogs.

In order to implement a customized reply style of the dialogue corpus, the example of the present disclosure may input a small quantity of chapter corpora with specific expression styles (e.g., a specific tone, mood, and expression mode) to the existing large language model in the first stage. By introducing data with specific expression styles, the existing large language model can generate a dialogue corpus that simulates the specific expression styles.

In some implementations, one example of a prompt input into the existing large language model in the first stage is:

“Generate dialogue corpus according to the following chapter corpus, where both sides of the dialogue are a teacher and a student.

### Example 1:

Input: The Dream of the Red Mansions is one of the Four Great Classical Novels of Chinese literature. The commonly accepted version consists of 120 chapters, with the first 80 generally attributed to Cao Xueqin, a Qing Dynasty writer, and the last 40 by an unknown author, edited by Cheng Weiyuan and Gao E. The novel is set against the backdrop of the rise and fall of four major families, the Jia, Shi, Wang, and Xue, and centers on the tragic love and marriage stories of Jia Baoyu, Lin Daiyu, and Xue Baochai. It depicts the various aspects of life and is an epic work.

Output:

Student A: Teacher, I am reading the Dream of the Red Mansions but I feel the content is so rich that I don't know where to start.

Teacher: The Dream of the Red Mansions is indeed rich in content. You can start with its main storyline, which is the tragic love and marriage stories of Jia Baoyu, Lin Daiyu, and Xue Baochai.

Student A: I see. Who is the author of this book?

Teacher: Generally, it is believed that the first 80 chapters of the Dream of the Red Mansions were written by Cao Xueqin, a famous writer of the Qing Dynasty. The last 40 chapters were written by an unknown author and later edited and published by Cheng Weiyuan and Gao E.

Student A: Oh, what about the background of the book?

Teacher: The Dream of the Red Mansions is set against the backdrop of the rise and fall of the Jia, Shi, Wang, and Xue families.

The chapter corpus which needs to be converted is as follows:

Input:

The Romance of the Three Kingdoms is a long chaptered historical romance novel written by Luo Guanzhong, a novelist from the late Yuan and early Ming dynasties, which is one of the Four Great Classical Novels of Chinese literature. The Romance of the Three Kingdoms describes nearly a century of historical events from the end of the Eastern Han Dynasty to the beginning of the Western Jin Dynasty, focusing mainly on the wars and depicting the political and military struggles among the states of Wei, Shu, and Wu.”

Based on the above prompt, the existing large language model can generate a dialogue corpus corresponding to the “chapter corpus to be converted” included in the prompt.

By inputting a small quantity of prompts of the aforementioned type, the existing large language model can generate a plurality of dialogue corpora, thereby creating a plurality of file pairs, each of which includes a chapter corpus and its corresponding dialogue corpus. The plurality of file pairs are used to fine-tune the own language model in the second stage. To enhance the quality of the file pairs generated in the first stage and consequently improve the fine-tuning effect on the own language model, the example of the present disclosure may adopt at least the following modes:

### Mode I

In an example, the chapter corpus is input into a first model (e.g., an existing large language model), and a plurality of dialogue questions related to the chapter corpus are output from the first model; and
based on the chapter corpus and the plurality of dialogue questions, the first model outputs a corresponding dialogue corpus, where the dialogue corpus includes the plurality of dialogue questions and answers to the dialogue questions.

Through the above mode, the first model (e.g., the existing large language model) can be guided to generate dialogue corpora in steps. Specifically, in the first step, the dialogue questions within the dialogue corpus are generated; in the second step, answers to the dialogue questions are generated, thereby forming a complete dialogue corpus. This mode allows for more detailed guidance of the large language model through the steps, with each step being relatively simple. As a result, this mode enhances the effectiveness of the large language model, improves the quality of the file pairs, and consequently enhances the fine-tuning effect on the second model (e.g., the own language model).

For example, a typical prompt content input into the first model is as follows:

“Please present a plurality of dialogue questions for the following chapter corpus: . . . ”

The prompt is input into a large language model, and after the large language model outputs a plurality of dialogue questions corresponding to the chapter corpus, the following prompt is input into the large language model:

“Please generate a dialogue corpus based on the above chapter corpus and the plurality of dialogue questions.”

In the above example, two prompts are successively input into the first model, where the first prompt contains the content of the chapter corpus and requests the first model to generate a plurality of dialogue questions corresponding to the chapter corpus; and the second prompt requests the first model to generate the dialogue corpus corresponding to the chapter corpus based on the previous output. By sequentially outputting the two prompts, the guidance to the first model is refined, thereby improving the effect of the first model in generating a high-quality dialogue corpus.

### Mode II

A prompt is generated for the chapter corpus, and the prompt carries a content of the chapter corpus and identity characteristics of dialogue participants; the identity characteristics of the dialogue participants are used to enable the first model (e.g., the existing large language model) to output a dialogue corpus that satisfies the identity characteristics of the dialogue participants.

For example, in the above prompt example, “two parties of the dialogue are a teacher and a student” specifies the identity characteristics of the dialogue participants. By including the identity characteristics of the dialogue participants in the prompt, the large language model can generate a dialogue corpus that conforms to the identity characteristics. The file pairs generated by the dialogue corpus that conforms to the identity characteristics can be used to fine-tune the own language model in the second stage, enabling the own language model to generate a dialogue corpus that conforms to identity characteristics of the dialogue participants.

### Mode III

The prompt is optimized by adopting a prompt optimization method; the optimized prompt is inputted into the first model (e.g., the existing large language model).

The example of the present disclosure may adopt a self-optimization manner such as a Chain-of-Thought (CoT) and In-Context Learning (ICL) to optimize the prompt, thereby improving the effect of the first model in the first stage and optimizing the output result of the first stage.

The CoT is a method for designing a prompt, i.e., the prompt contains, in addition to an input and output of tasks, intermediate steps of reasoning (intermediate thinking). The CoT can greatly enhance the ability of the LLM.

The ICL is a method that enables the large language model to learn from a specific task using a small quantity of annotated samples. The core idea of the method is to design a task- related instruction to form a prompt template, and guide the model to generate a prediction result on new test data by using the small quantity of annotated samples as prompts.

The core idea of self-optimization is to optimize a prompt by a large language model itself; specifically, the large language model records past iteration records, optimizes targets, summarizes rules by itself, and iterates the prompt gradually.

The above modes can optimize the prompt, and the optimized prompt can improve the performance of the first model, i.e., improve the effect of the first model in generating the dialogue corpus.

### Mode IV

The chapter corpus input into the first model (e.g., an existing large language model) has a predefined expression style, and the prompt input into the first model includes the identity characteristics of the dialogue participants. After the first model outputs a corresponding dialogue corpus, any dialogue corpus which does not conform to the predefined expression style and any dialogue corpus which is inconsistent with the identity characteristics of the dialogue participants are removed from an output result of the first model to obtain a remaining output result; and the plurality of file pairs are determined according to the remaining output result.

This process may clean the output results of the first model to remove lower-quality file pairs.

In some implementations, the expression style and/or identity characteristics of the dialogue corpus generated by the first model may be determined by the first model. For example, the dialogue corpus generated by the first model is re-inputted into the first model, such that the first model determines the expression style and/or identity characteristics of the dialogue corpus. Alternatively, other neural network models may be used to determine the expression style and/or identity characteristics of the dialogue corpus output from the first model.

By cleaning the output results from the first model in the first stage, file pairs with higher quality can be obtained. Using the file pairs with higher quality to adjust the second model in the second stage can lead to an improved performance of the second model.

Through the above modes, the quality of the file pairs generated by the first model in the first stage can be improved; in the subsequent process, using the file pairs with higher quality to adjust the second model can enhance the performance of the adjusted second model, so that the quality of the file generated by the adjusted second model is higher.

As seen from the above, the method for generating the file according to the example of the present disclosure can generate a small quantity of training samples in the specific vertical domain by using a small quantity of sample data and the existing large language model, and can improve the capability of the own language model in the specific vertical domain by using the training samples to fine-tune the own language model; then input a large quantity of chapter corpora into the adjusted language model, and generate a large quantity of dialogue corpora by the adjusted language model. By generating the large-scale, high-quality dialogue corpus, the requirement of the specific vertical domain can be better fulfilled. The dialogue corpora can cover professional knowledge, problem solutions and common scenes of the specific domain, so that the application of a related product in the domain becomes more comprehensive and practical.

In addition, the method for generating the file according to the example of the present disclosure can effectively protect data privacy by converting a confidential chapter corpus in a local own language model and performing fine-tuning by using the existing large language model. Meanwhile, compared with the direct use of the existing large language model, the method can save the cost and reduce the expense of using the large language model.

The dialogue corpus generated by the method for generating the file according to the example of the present disclosure can construct the own large language model and can fine-tune and optimize it in the specific vertical domain, so that the own large language model has unique technical advantages and differentiated features.

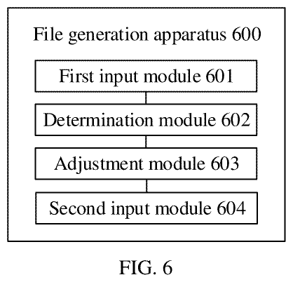

An example of the present disclosure further provides an apparatus for generating a file. FIG. 6 is a schematic block diagram illustrating an apparatus 600 for generating a file according to an example of the present disclosure, including:
a first input module 601, configured to input M1 first-type files into a first model, respectively, and output second-type files corresponding to the respective first-type files from the first model;
a determination module 602, configured to determine a plurality of file pairs according to an output result, where each file pair includes a first-type file and a second-type file corresponding to the first-type file;
an adjustment module 603, configured to adjust a second model by using the a plurality of file pairs; and
a second input module 604, configured to input M2 first-type files into an adjusted second model, respectively, and output the second-type files corresponding to the respective first-type files from the adjusted second model, where M1 and M2 are positive integers.

In some implementations, M2 is greater than M1.

In some implementations, the M2 first-type files include a file that needs to be secured.

In some implementations, the first-type file includes a chapter corpus and the second- type file includes a dialogue corpus.

In some implementations, the first input module 601 is configured to:
input the chapter corpus into the first model, and output a plurality of dialogue questions related to the chapter corpus from the first model; and
output a corresponding dialogue corpus from the first model based on the chapter corpus and the plurality of dialogue questions, where the dialogue corpus includes the plurality of dialogue questions and answers to the dialogue questions.

In some implementations, the first input module 601 is configured to generate a prompt for each chapter corpus and input the prompt into the first model; where the prompt carries a content of the chapter corpus and identity characteristics of dialogue participants; the identity characteristics of the dialogue participants are used to enable the first model to output a dialogue corpus that satisfies the identity characteristics of the dialogue participants.

In some implementations, the first input module 601 is configured to:
optimize the prompt by adopting a prompt optimization method; and
input an optimized prompt into the first model.

In some implementations, the chapter corpus has a predefined expression style.

In some implementations, the determination module 602 is configured to:
remove any dialogue corpus which does not conform to the predefined expression style and remove any dialogue corpus which is inconsistent with the identity characteristics of the dialogue participants from an output result of the first model, to obtain a remaining output result; and
determine a plurality of file pairs according to the remaining output result.

For a description of specific functions and examples of each module and each sub-module of the apparatus according to the example of the present disclosure, reference may be made to the related description of the corresponding steps in the foregoing method examples, and details thereof are not repeated herein.

In the technical solution of the present disclosure, the acquisition, storage and application of the user's personal information involved are all in compliance with the provisions of relevant laws and regulations, and do not violate public order and good customs.

According to the examples of the present disclosure, the present disclosure also provides an electronic device, a readable storage medium and a computer program product.

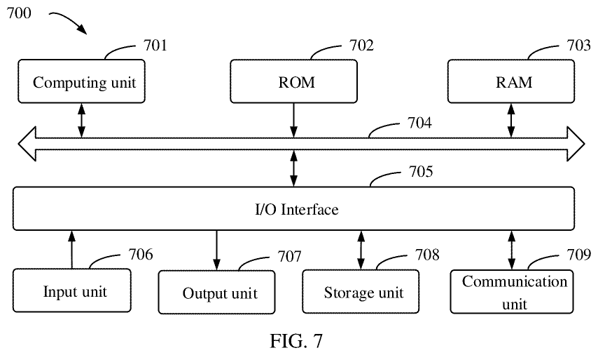

FIG. 7 shows a schematic block diagram of an exemplary electronic device 700 that may be used to implement the examples of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital assistant, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 7, the electronic device 700 includes a computing unit 701 that may perform various appropriate actions and processes according to a computer program stored in a Read-Only Memory (ROM) 702 or a computer program loaded from a storage unit 708 into a Random Access Memory (RAM) 703. Various programs and data required for an operation of the electronic device 700 may also be stored in the RAM 703. The computing unit 701, the ROM 702 and the RAM 703 are connected to each other via a bus 704. An input/output (I/O) interface 705 is also connected to the bus 704.

A plurality of components in the device 700 are connected to the I/O interface 705, and include an input unit 706 such as a keyboard, a mouse, or the like; an output unit 707 such as various types of displays, speakers, or the like; the storage unit 708 such as a magnetic disk, an optical disk, or the like; and a communication unit 709 such as a network card, a modem, a wireless communication transceiver, or the like. The communication unit 709 allows the electronic device 700 to exchange information/data with other devices via a computer network such as the Internet and/or various telecommunication networks.

The computing unit 701 may be various general-purpose and/or special-purpose processing components with processing and computing capabilities. Some examples of the computing unit 701 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 701 performs various methods and processing described above, such as the above method for generating a file. For example, in some implementations, the above method for generating a file may be implemented as a computer software program tangibly contained in a computer-readable medium, such as the storage unit 708. In some implementations, a part or all of the computer program may be loaded and/or installed on the device 700 via the ROM 702 and/or the communication unit 709. When the computer program is loaded into RAM 703 and executed by the computing unit 701, one or more steps of the method for generating a file described above may be performed. Alternatively, in other implementations, the computing unit 701 may be configured to perform the above method for generating a file by any other suitable means (e.g., by means of firmware).

Various implements of the system and technologies described above herein may be implemented in a digital electronic circuit system, an integrated circuit system, a Field Programmable Gate Array (FPGA), an Application Specific Integrated Circuit (ASIC), Application Specific Standard Parts (ASSP), a System on Chip (SOC), a Complex Programmable Logic Device (CPLD), a computer hardware, firmware, software, and/or a combination thereof.

These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the spirit and principle of the present disclosure shall be included in the protection scope of the present disclosure.

What is claimed is:

1. A method for generating a file, comprising:
inputting M1 first-type files into a first model, and outputting second-type files corresponding to the respective first-type files from the first model;
determining a plurality of file pairs according to an output result, wherein each file pair comprises a first-type file and a second-type file corresponding to the first-type file;
adjusting a second model by using the plurality of file pairs; and
inputting M2 first-type files into an adjusted second model, and outputting the second-type files corresponding to the respective first-type files from the adjusted second model, wherein M1 and M2 are positive integers.

2. The method of claim 1, wherein M2 is greater than M1.

3. The method of claim 1, wherein the M2 first-type files comprise a file to be secured.

4. The method of claim 1, wherein the M1 first-type files comprise a chapter corpus and the second-type files comprise a dialogue corpus.

5. The method of claim 4, wherein inputting the M1 first-type files into the first model, and outputting the second-type files corresponding to the respective first-type files from the first model comprises:
inputting the chapter corpus into the first model, and outputting a plurality of dialogue questions associated with the chapter corpus from the first model; and
outputting, from the first model, a corresponding dialogue corpus based on the chapter corpus and the plurality of dialogue questions, wherein the dialogue corpus comprises the plurality of dialogue questions and answers to the dialogue questions.

6. The method of claim 4, wherein inputting the M1 first-type files into the first model comprises:
generating a prompt for each chapter corpus and inputting the prompt into the first model,
wherein the prompt carries a content of the chapter corpus and identity characteristics of dialogue participants; and the identity characteristics of the dialogue participants are configured to enable the first model to output a dialogue corpus that satisfies the identity characteristics of the dialogue participants.

7. The method of claim 6, wherein inputting the prompt into the first model comprises:
optimizing the prompt by adopting a prompt optimization method; and
inputting an optimized prompt into the first model.

8. The method of claim 6, wherein the chapter corpus has a predefined expression style.

9. The method of claim 8, wherein determining the plurality of file pairs according to the output result comprises:
removing any dialogue corpus which does not conform to the predefined expression style, and removing any dialogue corpus which is inconsistent with the identity characteristics of the dialogue participants from an output result of the first model to obtain a remaining output result; and
determining the plurality of file pairs according to the remaining output result.

10. An electronic device, comprising:
at least one processor; and
a memory connected in communication with the at least one processor,
wherein the memory stores an instruction executable by the at least one processor, and the instruction, when executed by the at least one processor, enables the at least one processor to execute:
inputting M1 first-type files into a first model and outputting second-type files corresponding to the respective first-type files from the first model;
determining a plurality of file pairs according to an output result, wherein each file pair comprises a first-type file and a second-type file corresponding to the first-type file;
adjusting a second model by using the plurality of file pairs; and
inputting M2 first-type files into an adjusted second model and outputting the second-type files corresponding to the respective first-type files from the adjusted second model, wherein M1 and M2 are positive integers.

11. The electronic device of claim 10, wherein M2 is greater than M1.

12. The electronic device of claim 10, wherein the M2 first-type files comprise a file to be secured.

13. The electronic device of claim 10, wherein the M1 first-type files comprise a chapter corpus and the second-type files comprise a dialogue corpus.

14. The electronic device of claim 13, wherein the instruction, when executed by the at least one processor, enables the at least one processor to execute inputting the M1 first-type files into the first model, and outputting the second-type files corresponding to the respective first-type files from the first model by:
inputting the chapter corpus into the first model, and outputting a plurality of dialogue questions related to the chapter corpus from the first model; and
outputting, from the first model, a corresponding dialogue corpus based on the chapter corpus and the plurality of dialogue questions, wherein the dialogue corpus comprises the plurality of dialogue questions and answers to the dialogue questions.

15. The electronic device of claim 13, wherein the instruction, when executed by the at least one processor, enables the at least one processor to execute inputting the M1 first-type files into the first model by:
generating a prompt for each chapter corpus and inputting the prompt into the first model,
wherein the prompt carries a content of the chapter corpus and identity characteristics of dialogue participants; and the identity characteristics of the dialogue participants are used to enable the first model to output a dialogue corpus that satisfies the identity characteristics of the dialogue participants.

16. A non-transitory computer readable storage medium storing a computer instruction wherein the computer instruction causes a computer to perform:
inputting M1 first-type files into a first model and outputting second-type files corresponding to the respective first-type files from the first model;
determining a plurality of file pairs according to an output result, wherein each file pair comprises a first-type file and a second-type file corresponding to the first-type file;
adjusting a second model by using the plurality of file pairs; and
inputting M2 first-type files into an adjusted second model and outputting the second-type files corresponding to the respective first-type files from the adjusted second model, wherein M1 and M2 are positive integers.

17. The non-transitory computer readable storage medium of claim 16, wherein M2 is greater than M1.

18. The non-transitory computer readable storage medium of claim 16, wherein the M2 first-type files comprise a file to be secured.

19. The non-transitory computer readable storage medium of claim 16, wherein the M1 first-type files comprise a chapter corpus and the second-type files comprise a dialogue corpus.

20. The non-transitory computer readable storage medium of claim 19, wherein the computer instruction further causes the computer to perform inputting the M1 first-type files into the first model, and outputting the second-type files corresponding to the respective first-type files from the first model by:
inputting the chapter corpus into the first model, and outputting a plurality of dialogue questions related to the chapter corpus from the first model; and
outputting, from the first model, a corresponding dialogue corpus based on the chapter corpus and the plurality of dialogue questions, wherein the dialogue corpus comprises the plurality of dialogue questions and answers to the dialogue questions.
